(19) United States
(12) Patent Application Publication
(10) Pub. No.: US 2007/0005836 A1
(43) Pub. Date: Jan. 4, 2007

(54) Memory having swizzled signal lines

(76) Inventors: Sandeep Jain, Milpitas, CA (US); George Vergis, Hillsboro, OR (US); John Halbert, Beaverton, OR (US); Nilesh V. Shah, Folsom, CA (US)

Correspondence Address: MARGER JOHNSON & MCCOLLOM, P.C., 210 SW MORRISON STREET, SUITE 400, PORTLAND, OR, 97204, US

(21) Appl. No.: 11/148,160

(22) Filed: Jun. 7, 2005

(51) Int. Cl. G06F 13/38

(52) U.S. Cl. 710/62

(57) ABSTRACT

Swizzle information for signal lines on a memory component may be stored on the memory component. The swizzle information may be transmitted to a memory controller which may include logic to receive the swizzle information which is then used to deswizzle data received from the memory component. Data may be transmitted from a memory device to a memory controller in a format that is tolerant of swizzling on signal lines between the device and the controller. The format may include codes having unique of numbers of values. Data may be sent in multi-code bursts that divide a data range into progressively smaller ranges. Other embodiments are described and claimed.

### BACKGROUND

FIG. 1 illustrates a prior art memory system having a memory controller 10 mounted on a computer mother board 11, a memory connector 12 and a memory module 14 that is populated with multiple memory devices 16. The memory controller is typically part of a microprocessor or chipset residing on the mother board. The memory devices 16 may be fabricated directly on the mother board, but to allow for expansion, upgrade, service, and other considerations, they are commonly located on one or more modules that plug into connectors on the mother board. Although many connector schemes have been devised, the memory connector 12 is most commonly a card-edge connector that is mounted on the mother board. In this type of arrangement, the memory module has a connector edge that slides into the card-edge connector. Conductive strips on the edge of the module engage spring-loaded contacts in the card-edge connector to provide an electrical connection between signal line traces on the mother board and signal line traces on the memory module.

In the system of FIG. 1, the signal lines D0-D3 are routed in a straightforward manner between the corresponding terminals on the controller, connector, module and memory devices. Straightforward routing, however, may be difficult to achieve, especially as memory systems use ever increasing numbers of signal lines and memory devices.

To ease the signal routing requirements in memory systems, the signal lines may be swizzled on the mother board and/or the memory module as shown in FIG. 2. For example, the signal D2 originating at the memory controller is routed through the terminal for D1 on the connector and ends up at the terminals for signal D0 on the memory devices. Although less common, the signals lines may also be swizzled between the individual memory devices as shown by the broken lines in FIG. 2.

In a system having memory devices that only handle read/write data, e.g., dynamic random access memory (DRAM), the memory controller may be unaware of the swizzled signal lines because data that was written to the memory devices is automatically deswizzled when it is read back to the memory controller. That is, even though data sent out from the controller on the terminals for D0, D1, D2, and D3 travels through convoluted signal paths so that it ends up being written to the locations designed D3, D1, D0, D2, respectively, at the memory devices, it traverses the same signal paths in the reverse order during a read operation, so it ends up at the controller at the correct terminals. Thus, the controller need not be aware of which signal lines on the memory devices correspond to which signal lines on the controller.

FIG. 3 illustrates a prior art memory module having memory devices 16 mounted on a substrate 15, which is typically a printed circuit board (PC board). One edge of the module is a connector edge 13 having conductive terminal strips for engaging contacts in a card-edge connector. Signal line traces, which may be swizzled, connect the memory devices to the terminal strips. The module also includes a serial presence detect (SPD) device 17 which is a serial electrically erasable programmable read only memory (EEPROM) chip that stores information about the module such as size, speed, operating voltage, drive strength, number of row and column addresses, and manufacturer information. The SPD is programmed during the manufacturing process and communicates with the basic input/output services (BIOS) code through a separate serial interface, typically during a power-on self-test (POST). The information in the SPD allows the BIOS to properly configure the system to fit the performance profiles of the memory devices on the module.

### BRIEF DESCRIPTION OF THE DRAWINGS

FIG. 1 illustrates a prior art memory system.

FIG. 2 illustrates a prior art memory system having swizzled signal lines.

FIG. 3 illustrates a prior art memory module.

FIG. 4 illustrates an embodiment of a sequence of training patterns according to the inventive principles of this patent disclosure.

FIG. 5 illustrates another embodiment of a sequence of training patterns according to the inventive principles of this patent disclosure.

FIG. 6 illustrates another embodiment of a sequence of training patterns according to the inventive principles of this patent disclosure.

FIG. 7 illustrates an embodiment of a memory system according to the inventive principles of this patent disclosure.

FIG. 8 illustrates an example embodiment of logic for generating and transmitting read-only temperature data and training sequences according to the inventive principles of this patent disclosure.

FIG. 9 illustrates an embodiment of logic for receiving and deswizzling read data from a memory device according to the inventive principles of this patent disclosure.

FIG. 10 illustrates an embodiment of deswizzle logic according to the inventive principles of this patent disclosure.

FIG. 11 illustrates an embodiment of a memory module according to the inventive principles of this patent disclosure.

FIG. 12 illustrates an embodiment of logic for receiving swizzle information and deswizzling data according to the inventive principles of this patent disclosure.

FIG. 13 illustrates an embodiment of a memory system utilizing stored swizzle information according to the inventive principles of this patent disclosure.

FIG. 14 illustrates an embodiment of a memory system utilizing swizzle tolerant encoding according to the inventive principles of this patent disclosure.

FIG. 15 illustrates an embodiment of codes for encoding temperature data to divide a temperature range into smaller ranges according to the inventive principles of this patent disclosure.

FIGS. 16-18 illustrate embodiments of codes for encoding temperature data to divide temperature ranges into progressively smaller temperature ranges according to the inventive principles of this patent disclosure.

FIG. 19 illustrates an example of temperature data to be transmitted from memory devices to a memory controller according to the inventive principles of this patent disclosure.

FIG. 20 illustrates an example embodiments of bit patterns transmitted from memory devices to a memory controller according to the inventive principles of this patent disclosure.

FIG. 21 illustrates an example embodiment of timing signals for transferring data in a swizzle tolerant format according to the inventive principles of this patent disclosure.

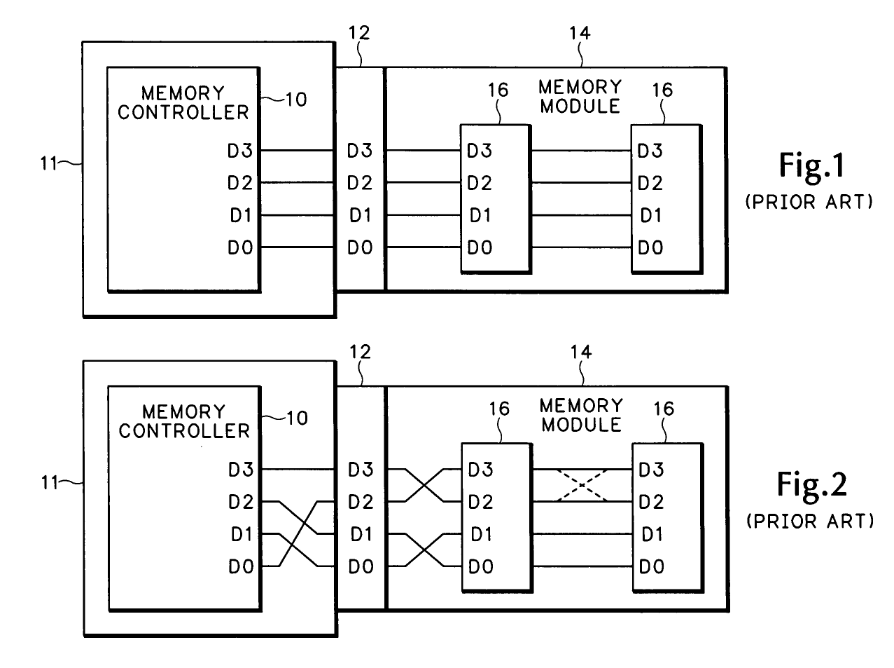

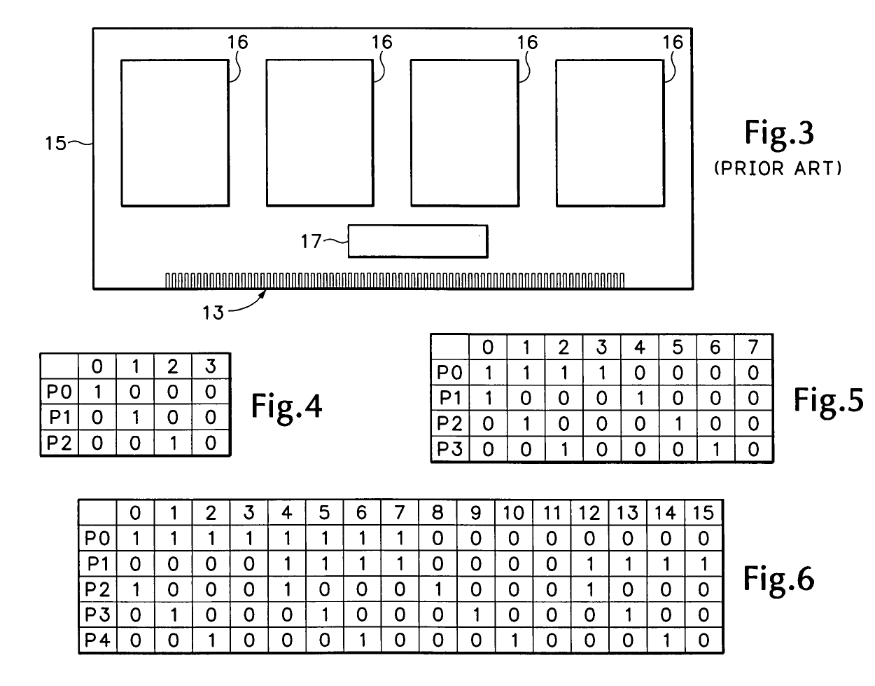

### DETAILED DESCRIPTION

This patent disclosure encompasses numerous inventive principles that have independent utility. In some cases, additional benefits may be realized when some of the principles are utilized in various combinations with one another, thus giving rise to additional inventions. These principles may be realized in countless embodiments. Although some specific details are shown for purposes of illustrating the inventive principles, numerous other arrangements may be devised in accordance with the inventive principles of this patent disclosure. Thus, the inventive principles are not limited to the specific details disclosed here.

### Training Sequence For Deswizzling Signals

Although a memory controller need not be aware of swizzled signal lines when working with read/write data, swizzled signal lines may be problematic for data that originates at devices other than the controller. For example, the memory devices 16 in FIG. 2 may generate temperature data that is transmitted to the memory controller for thermal management purposes. Such data is read-only data from the perspective of the memory controller because the controller did not transmit the data to the memory device. Without knowing if and how the signal lines are swizzled, the data arrives jumbled at the controller which does not know how to interpret the data received on the signal lines D0-D3.

In a memory system according to the inventive principles of this patent disclosure, a deswizzling training sequence of may be sent so that the controller may identify the location of data on the various signal lines. For example, FIG. 4 illustrates an embodiment of a training sequence having training patterns P0, P1, and P2 for deswizzling four binary value bit lines in a memory system. Pattern P0, which has a logic 1 in the first bit position DQ[0], and logic 0s in the other three bit positions DQ[1-3], is sent first to the memory controller. By looking for the only bit line with a logic 1, the controller is able to identify which line is associated with the first bit of data. Patterns P1 and P2 are transmitted next to allow the controller to identify bit positions DQ[1] and DQ[2], respectively. A fourth pattern is not necessary because the remaining bit must be DQ[3].

For a module having X4 devices, the same pattern may be repeated for all devices on one rank of the module. For device level swizzling with no swizzling between the individual memory devices, the decoding may be done in parallel for all devices. However, if there is cross-device swizzling, a longer training pattern may be used.

FIG. 5 illustrates another embodiment of a deswizzling training sequence according to the inventive principles of this patent disclosure. The embodiment of FIG. 5, which, for purposes of illustration, enables deswizzling of eight bit lines in a memory system, utilizes different types of training patterns to identify groups of signal lines, and to identify individual signal lines within those groups. The first pattern P0 has logic 1s in bit positions 0-1 and logic 0s in bit positions 3-7. Pattern P0 may be used to identify the locations of the signals in the upper and lower four-bit nibbles, i.e., DQ[3:0] and DQ[7:4]. Then, patterns P1 through P3, which only have a logic 1 in one bit position per nibble, are used to identify the locations of the individual bits within each nibble. This embodiment may thus allow deswizzling at the X8 device level.

FIG. 6 illustrates another embodiment of a deswizzling training sequence according to the inventive principles of this patent disclosure. The embodiment of FIG. 6 allows deswizzling at the X16 device level. Pattern P0 identifies the upper and lower eight-bit byte locations DQ[15:8] and DQ[7:0]. Pattern P1 identifies the nibbles within each byte, and patterns P2 through P4 identify the individual locations within each nibble.

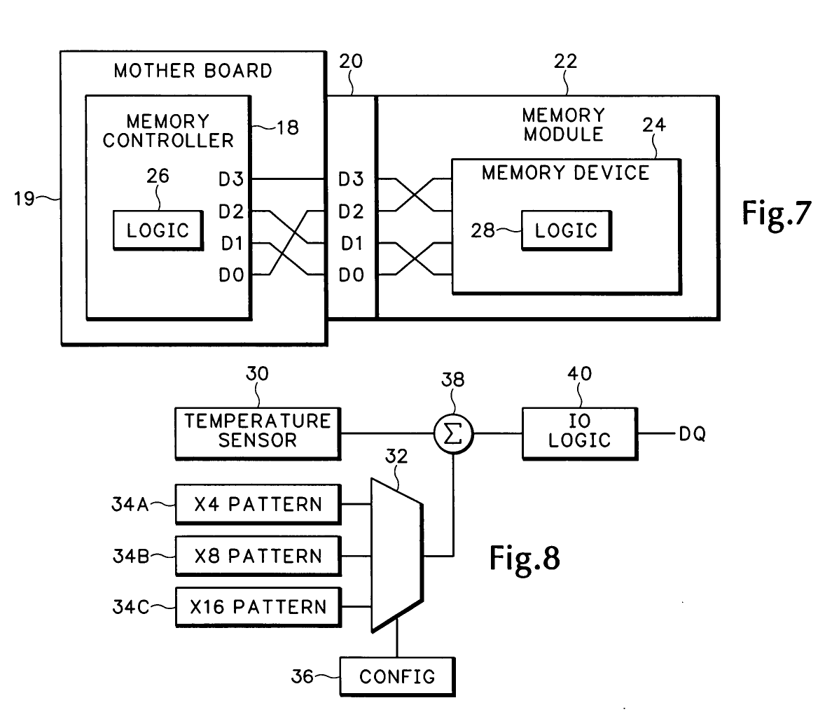

FIG. 7 illustrates an embodiment of a memory system according to the inventive principles of this patent disclosure. In the system of FIG. 7, a memory device 24 includes logic 28 to generate and transmit read-only data, and to transmit a training sequence to allow deswizzling of any signal lines that may be swizzled between the memory device and a memory controller 18 located on a mother board 19. Read-only data refers to any data that was not written to memory from the apparatus that is now attempting to read the data, i.e., data that is not automatically deswizzled by virtue of traversing the swizzled signal paths in the reverse direction. The memory controller includes logic 26 to derive swizzle information from the training sequence and to deswizzle data on the incoming signal lines.

The embodiment of FIG. 7 is shown with four swizzled signal lines, but the inventive principles of this patent disclosure apply to systems having any number of swizzled (or potentially swizzled) signal lines. For double data rate (DDR) technology, DQ[63:0] may normally be connected to one channel of a DRAM module to the memory controller, and the P0 pattern may be different for all device configurations and can be used by the controller to know how long the training sequence will be. Likewise, memory module 22 is shown having only a single memory device, but the inventive principles apply to systems having any number of memory devices arranged individually or in stacks, behind buffers, on different modules, etc.

FIG. 8 illustrates an example embodiment of logic for generating and transmitting read-only temperature data and training sequences according to the inventive principles of this patent disclosure. A temperature sensor 30 generates temperature data based on the temperature of a memory device, memory module, or other apparatus. A multiplexer 32 selects a sequence of training patterns 34A-C depending on the arrangement of memory devices, e.g., X4, X8, X16, etc. A configuration register 36 stores configuration information that the multiplexer uses to determine which training sequence to select. Appending logic 38 appends the selected training sequence to the temperature data which is then transmitted through I/O logic 40. In one embodiment, the training sequence may be appended and transmitted whenever temperature data is transmitted. Alternatively, the training sequence may instead be transmitted every time a memory device or module is initialized.

The embodiment of FIG. 8 may be adapted for use as the logic 28 in the memory device 24 of FIG. 7. The placement of components is not limited to any particular arrangement. For example, all of the components may be located on one memory device. Alternatively, some of the components may be located on a memory device with the remainder residing on a memory module.

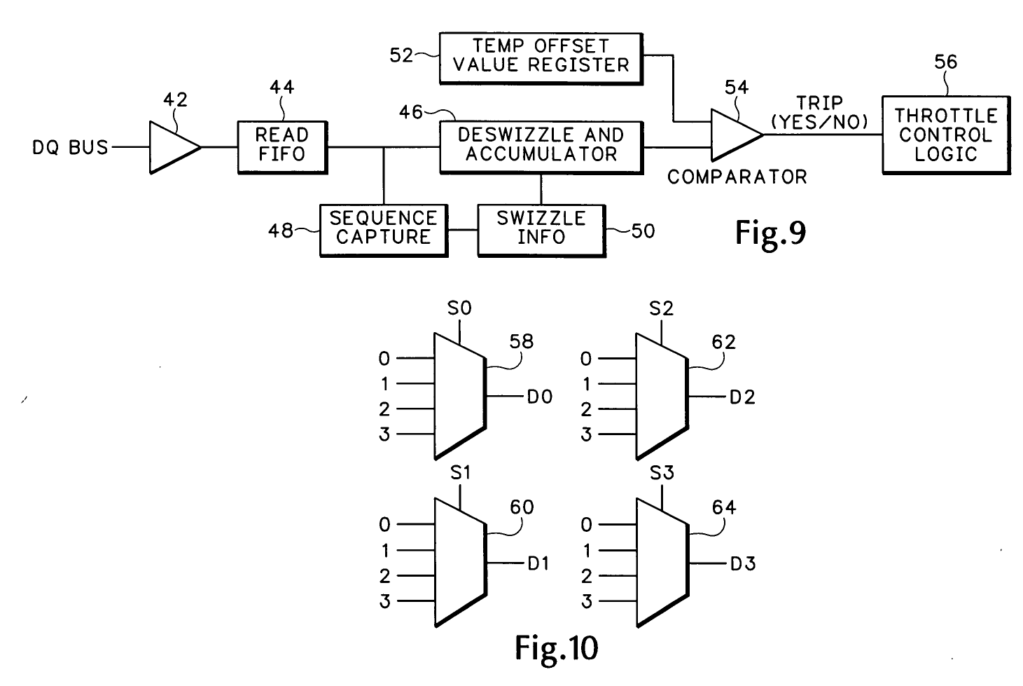

FIG. 9 illustrates an embodiment of logic for receiving and deswizzling read data from a memory device according to the inventive principles of this patent disclosure. Data is received on a signal bus DQ, and after making its way through a buffer 42 and first-in-first-out (FIFO) memory 44, arrives at a deswizzler and accumulator 46. To implement a deswizzling operation, the embodiment of FIG. 8 includes a register 48 that captures training sequences which have been swizzled (or perhaps, deswizzled) by the signal paths between it and the source of the training sequence. Logic 50 processes the patterns in the swizzled training sequence to derive swizzle information that may be used to deswizzle subsequent data.

The embodiment of FIG. 9 may be adapted for use as the logic 26 in memory controller 18 of FIG. 6, for example, to deswizzle temperature data from a memory device. Thus, it also includes a register 52 for storing a temperature offset value, and a comparator 54 for comparing the stored temperature offset value to the actual temperature data. The result of the comparison operation is a yes/no trip signal that may be used by throttle control logic 56 for thermal management purposes.

FIG. 10 illustrates an embodiment of deswizzle logic suitable for use with the embodiment of FIG. 9 according to the inventive principles of this patent disclosure. Multiplexers 58, 60, 62, and 64 may selectively connect data from any of four signal paths 0-3 to deswizzled data lines D0 through D3. The multiplexers are controlled by select signals S0 through S3 which are generated in response to the swizzle information derived by logic 50 in the embodiment of FIG. 9. For purposes of illustration, the embodiment of FIG. 10 is shown as four-bit deswizzle logic, but the inventive principles are applicable to other configurations, and the logic can be optimized for other devices as well.

### Swizzle Information Stored On Memory Component

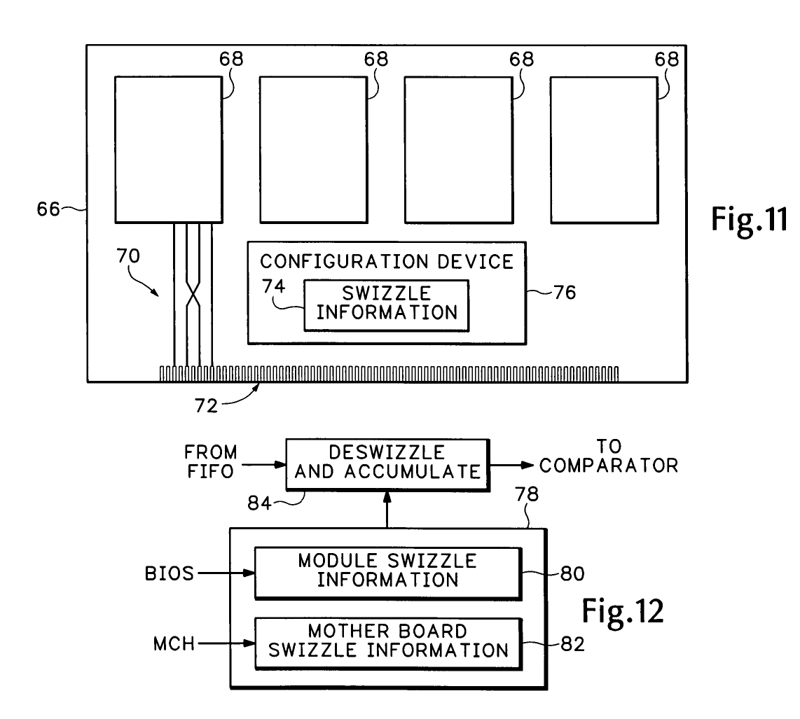

Some additional inventive principles of this patent disclosure relate to storing swizzle information for a memory component on the memory component itself. For example, FIG. 11 illustrates an embodiment of a memory module according to the inventive principles of this patent disclosure. The embodiment of FIG. 11 includes a printed circuit board (PC board) substrate 66 that holds memory devices 68. Signal line traces 70, which may be swizzled, connect the memory devices to terminal strips on a connector edge 72 for engaging contacts in a card-edge connector.

Swizzle information 74 for the signal lines on the memory module is stored in a configuration device 76. The swizzle information may be transmitted to a memory controller by any appropriate technique. The memory controller may then combine the swizzle information for signal lines on the memory module with swizzle information for signal lines on the mother board to determine overall swizzling between the memory devices and the controller. The controller may then apply the appropriate deswizzling to read only data received from each memory device.

The configuration device 76 may be, for example, a serial presence detect (SPD) device that communicates swizzle information to basic input/output services (BIOS) through a separate serial interface, e.g., during a power-on self-test (POST). However, the location in which the swizzle information is stored on the memory module is not limited to any particular device. Likewise, a memory component having swizzle information stored according to the inventive principles of this patent disclosure can take forms other than a memory module. For example, the components illustrated in the embodiment of FIG. 11 may be fabricated directly on a mother board with the memory controller, thereby eliminating the need for connectors.

FIG. 12 illustrates an embodiment of logic for receiving swizzle information and deswizzling read data from a memory device according to the inventive principles of this patent disclosure. The embodiment of FIG. 12 includes logic 78 that receives module swizzle information 80 from, e.g., BIOS, and mother board swizzle information 82 from, e.g., a memory controller hub (MCH). The logic then combines the swizzle information to determine overall swizzling between the memory devices and the controller which is then used to deswizzle read data in a deswizzler and accumulator 82. The embodiment of FIG. 12 may be used to deswizzle read only data such as temperature data from a memory device in a manner similar to that illustrated in the embodiment of FIG. 9. The deswizzler and accumulator 82 may be implemented with deswizzling multiplexers similar to those shown in the embodiment of FIG. 10.

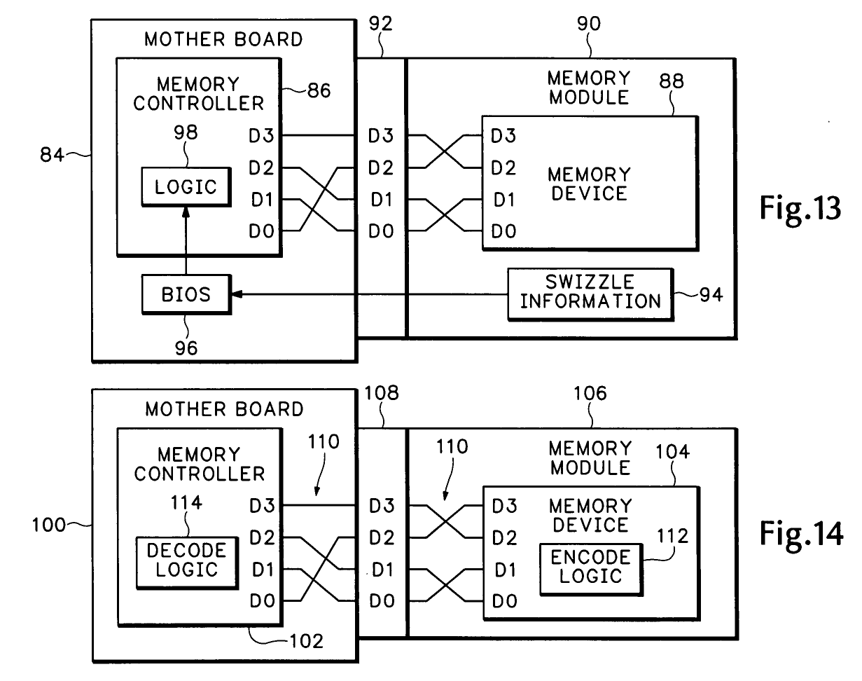

FIG. 13 illustrates an embodiment of a memory system utilizing stored swizzle information according to the inventive principles of this patent disclosure. The embodiment of FIG. 13 includes a mother board 84 having a memory controller 86 in communication with memory devices 88 on module 90 through a connector 92. Signal line traces on the mother board, which may be swizzled, connect the memory controller to the connector. Signal line traces on the module, which may also be swizzled, connect the memory devices 88 to the connector 92. The module contains swizzle information 94, which may be stored on a configuration device. The memory controller includes logic 98 to receive the swizzle information for the signal lines on the memory module and deswizzle data received over the signal lines on the memory module. The mother board may include program code 96, which may be, for example BIOS program code, to provide the swizzle information 94 to the logic 98 in the memory controller.

### Swizzle Tolerant Encoding

Some additional inventive principles of this patent disclosure relate to the use of swizzle tolerant encoding. FIG. 14 illustrates an embodiment of a memory system according to the inventive principles of this patent disclosure. The embodiment of FIG. 14 includes a mother board 100 having a memory controller 102 in communication with a memory device 104 on a memory module 106 that is mounted to the mother board through a connector 108. The memory controller is connected to the memory device through signal lines 110 which may be swizzled on the mother board and/or the memory module.

The memory device includes logic 112 to encode data in a swizzle tolerant format, while the memory controller includes logic 114 to decode the data in the swizzle tolerant format. A swizzle tolerant encoding format according to the inventive principles of this patent disclosure may have unique numbers of values for each code. For example, in a system having binary (ones and zeros) signaling values, each code may have a unique number of ones or zeros. Thus, if a code arrives at its destination with the individual bit lines jumbled, it may still be decoded properly because the number of ones or zeros is still the same, regardless of which individual signal lines they arrive on.

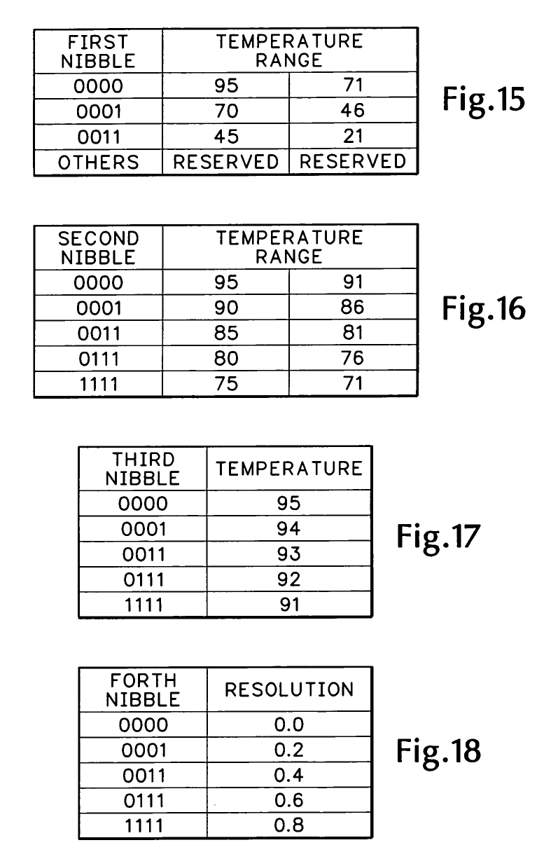

An example embodiment of a swizzle tolerant encoding format according to the inventive principles of this patent disclosure will be described in the context of a third generation double data rate (DDR3) memory system in which memory devices may send temperature data in the range of 21-95° C. to a memory controller in codes of four-bit, binary-valued nibbles. FIG. 15 illustrates the coding for the first nibble which divides the 55 C full-range temperature span into smaller 24 C ranges of 21-45, 46-70 and 71-100. FIGS. 16, 17 and 18 illustrate how the next nibbles subdivide the ranges into smaller and smaller ranges until a resolution of 0.2 C is achieved. For simplicity, only the highest end of each range is shown divided into smaller ranges, but similar subdivisions are applicable to each sub-range.

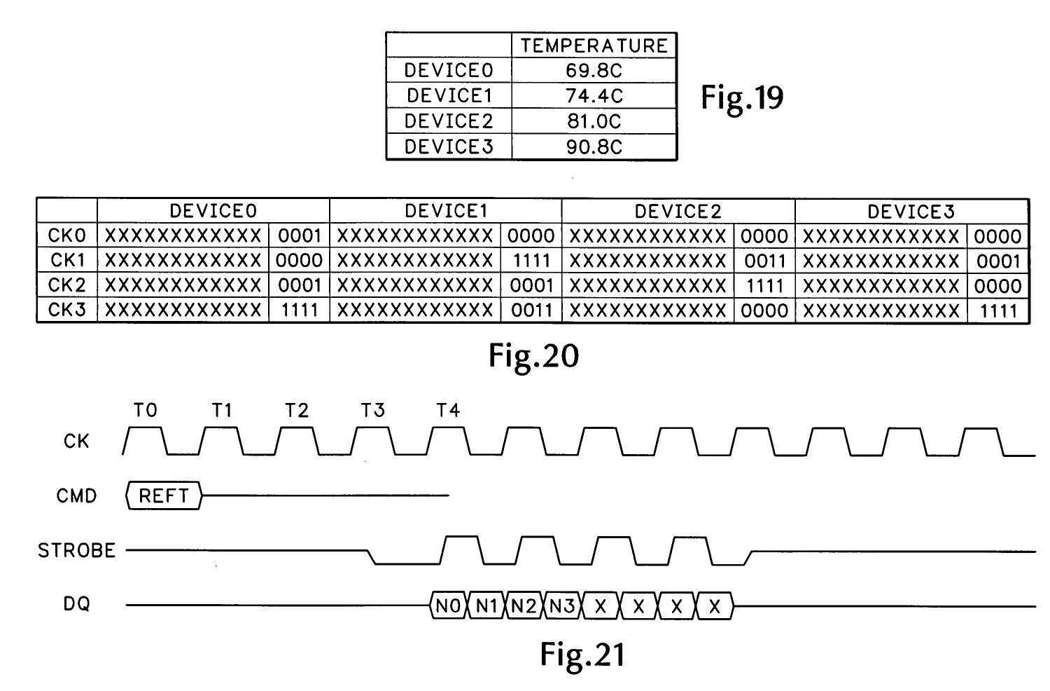

FIGS. 19-21 illustrate how the encoding format described above with respect to FIGS. 15-18 may be utilized in a system having an X16 single rank module which has four memory devices designated as devices 0-4. FIG. 19 illustrates example device temperatures that may need to be sent to a memory controller. FIG. 20 illustrates the actual data sent by each device during four clock cycles in the form of four nibbles (quadwords). All data may be sent simultaneously by each memory device on the DQ bus. FIG. 21 illustrates example timing in which the memory devices return temperature data on the DQ bus in a burst of four nibbles in response to a temperature read command REFT.

Although the example embodiments of FIG. 15-21 illustrate systems that transfer temperature data, the inventive principles may be used to encode other types of read-only data, read/write data, or any other types of data. Likewise, although the logic for encoding and decoding data are shown within the memory device and memory controller, respectively, in FIG. 14, the logic may be located in any other convenient location, it may be implemented in software, etc.

Thus, it is apparent that the embodiments described herein may be modified in arrangement and detail without departing from the inventive principles. Just a few additional examples of the countless possible variations are as follows. The components need not be implemented in a module configuration with connectors, but instead could be fabricated directly on a mother board. The memory modules described above are not limited to any particular type of substrate or memory devices. As another example, the techniques disclosed above for deswizzling “data” signals may also be used for address and command signals as well as status and any other types of signals. Memory controllers and memory devices may be connected through buffers and other components besides the connectors described above. As yet another example, logic that may have been shown implemented in hardware, e.g., the logic shown in FIG. 8, need not necessarily be implemented as hardware, but may be amenable to software implementation as well. The principles of swizzle tolerant encoding according to the inventive principles of this patent disclosure are not limited to encoding systems having only binary values, but apply to multi-valued logic as well. Coding formats are not limited to any particular number of bits per word, number of words per burst, number of unique values per code, etc. Accordingly, such changes and modifications are considered to fall within the scope of the following claims.

1. A memory component comprising:
a memory device;
signal lines coupled to the memory device; and
swizzle information for the signal lines.

2. The memory component of claim 1 further comprising a configuration device to store the swizzle information.

3. The memory component of claim 2 where the configuration device comprises a serial presence detect device.

4. The memory component of claim 2 where the configuration device is capable of sending the swizzle information in response to a request from BIOS.

5. The memory component of claim 1 where the memory component comprises a memory module.

6. The memory component of claim 5 where the signal lines are coupled between the memory device and a connector attached to the module.

7. The memory component of claim 1 where the memory component comprises a portion of a computer mother board.

8. A method comprising storing swizzle information for a memory component at the memory component.

9. The method of claim 8 further comprising sending the swizzle information to a memory controller coupled to the memory component.

10. The method of claim 9 further comprising:
transmitting data from the memory component to the memory controller; and
deswizzling the data in response to the swizzle information.

11. The method of claim 9 where sending the swizzle information to the memory controller comprises reading the swizzle information during a BIOS operation.

12. The method of claim 8 where the swizzle information is stored in a configuration device.

13. The method of claim 12 where the configuration device is a serial presence detect device.

14. The method of claim 8 where the memory component is a memory module.

15. A memory component comprising:
a memory device; and
logic to encode data from the memory device in a format that is tolerant of swizzled signal lines.

16. The memory component of claim 15 where the format comprises codes having unique numbers of values.

17. The memory component of claim 16 where the values are binary values.

18. The memory component of claim 15 where the logic to encode data comprises logic to encode data in code bursts.

19. The memory component of claim 15 where each code burst comprises a bust of nibbles.

20. The memory component of claim 15 where the format comprises codes that divide the data into ranges.

21. The memory component of claim 15 where the component comprises a memory module.

22. The memory component of claim 15 further comprising signal lines that may be swizzled.

23. The memory component of claim 15 where the memory device comprises the logic to encode data.

24. A method comprising:
transmitting data from a memory device to a memory controller over signal lines; and
encoding the data in a format that is tolerant of swizzling of the signal lines.

25. The method of claim 24 further comprising decoding the data in the format that is tolerant of swizzling of the signal lines.

26. The method of claim 25 further comprising comparing the data to an offset value.

27. The method of claim 24 where the format comprises codes having unique numbers of values.

28. The method of claim 27 where the values are binary values.

29. The method of claim 24 where the format comprises codes that divide the data into ranges.

30. The method of claim 29 where the data comprises temperature data, and the ranges comprise temperature ranges.
